(19) United States
(12) Patent Application Publication
(10) Pub. No.: US 2026/0212133 A1
(43) Pub. Date: Jul. 23, 2026

(54) ELECTRONIC DEVICE AND METHOD FOR OPERATING VIRTUAL ASSISTANT THEREOF

(71) Applicant: ASUSTeK COMPUTER INC., Taipei City (TW)

(72) Inventors: Yi-Nan Lee, Taipei City (TW); Shih-Chieh Liao, Taipei City (TW); Chin-Hao Chang, Taipei City (TW); Shih-Chuan Chiu, Taipei City (TW); Tzu-Hung Chuang, Taipei City (TW); Chia-Hao Kang, Taipei City (TW); Wei-Cheng Chen, Taipei City (TW)

(73) Assignee: ASUSTeK COMPUTER INC., Taipei City (TW)

(21) Appl. No.: 19/449,383

(22) Filed: Jan. 14, 2026

(30) Foreign Application Priority Data
Jan. 22, 2025 (TW) 114102679

(51) Int. Cl. G06F 40/40; G06F 16/334; G06F 40/30

(52) U.S. Cl. CPC G06F 40/40; G06F 16/3344; G06F 40/30

(57) ABSTRACT

An electronic device and a method for operating virtual assistant thereof are provided. The method is adapted to the electronic device including an input device and an output device and includes the following steps. A user command is received via a virtual assistant through the input device. A semantic search result is obtained by using a language embedding model to perform a semantic search in a database that records a plurality of function description texts according to the user command. According to the semantic search result, a target prompt instruction including a target text among the function description texts or the user command is generated. The target prompt instruction is input into a generative natural language model, and a model reply text of the generative natural language model is output through the output device.

### CROSS-REFERENCE TO RELATED APPLICATION

This application claims the priority benefit of Taiwan application serial no. 114102679, filed on January 22, 2025. The entirety of the above-mentioned patent application is hereby incorporated by reference herein and made a part of this specification.

### BACKGROUND

### TECHNICAL FIELD

The disclosure relates to an electronic device and a virtual assistant operation method thereof.

### Related Art

With the advancement of technology, virtual assistants running in the background have been widely applied to devices such as mobile phones, computers, and smart speakers. Current virtual assistants can assist in handling some simple tasks; however, virtual assistants on existing devices typically can only understand a limited set of predefined instructions, making it difficult to meet users' diverse needs, thus affecting the user experience. On the other hand, virtual assistants on existing devices may also utilize cloud-based large-scale models or language analysis systems to parse user requests. Although cloud services have a deeper understanding of natural language, the potential network latency they may generate, as well as the risk of user privacy being uploaded to the cloud, often lead to limited user experience and even raise privacy and security concerns.

### SUMMARY

The disclosure provides a virtual assistant operation method, applicable to an electronic device including an input device and an output device. This method includes the following steps. A user command is received via the virtual assistant through the input device. A language embedding model is utilized to perform a semantic search in a database recording multiple function description texts based on the user command, thereby obtaining a semantic search result. According to the semantic search result, a target prompt instruction including a target text among the function description texts or the user command is generated. The target prompt instruction is inputted to a generative natural language model, and the model reply text of the generative natural language model is output through the output device.

The disclosure provides an electronic device, which includes an output device, an input device, a storage device, and a processor. The storage device records multiple instructions. The processor is coupled to the output device, the input device, and the storage device, and is configured to execute the aforementioned instructions to perform the following operations. A user command is received via the virtual assistant through the input device. A language embedding model is utilized to perform a semantic search in a database recording multiple function description texts based on the user command, thereby obtaining a semantic search result. According to the semantic search result, a target prompt instruction including a target text among the function description texts or the user command is generated. The target prompt instruction is inputted to a generative natural language model, and the model reply text of the generative natural language model is output through the output device.

Based on the above, in an embodiment of the disclosure, a semantic search may be conducted in a database recording multiple function description texts according to the user command, to generate a target prompt instruction to be input to the generative natural language model based on the semantic search result. Thus, the target prompt instruction may be input to the generative natural language model to generate a model reply text, allowing the virtual assistant to provide the model reply text to the user via the output device. As a result, this may enable the virtual assistant to effectively understand diverse user commands and improve the correctness and accuracy of the virtual assistant's replies based on the recorded data in the database.

### BRIEF DESCRIPTION OF THE DRAWINGS

FIG. 1 is a block diagram illustrating an electronic device according to an embodiment of the disclosure.

FIG. 2 is a flowchart illustrating a virtual assistant operation method according to an embodiment of the disclosure.

FIG. 3 is a schematic diagram illustrating a virtual assistant operation method according to an embodiment of the disclosure.

FIG. 4A and FIG. 4B are flowcharts illustrating a virtual assistant operation method according to an embodiment of the disclosure.

FIG. 5 is a schematic diagram illustrating a virtual assistant according to an embodiment of the disclosure.

### DESCRIPTION OF THE EMBODIMENTS

Some embodiments of the disclosure will now be described in detail with reference to the accompanying drawings. When the same reference numerals appear in different drawings, they will be considered as the same or similar components. These embodiments are only a part of the invention and do not disclose all possible embodiments of the invention. More precisely, these embodiments are examples of the devices and methods within the scope of the patent claims of the disclosure.

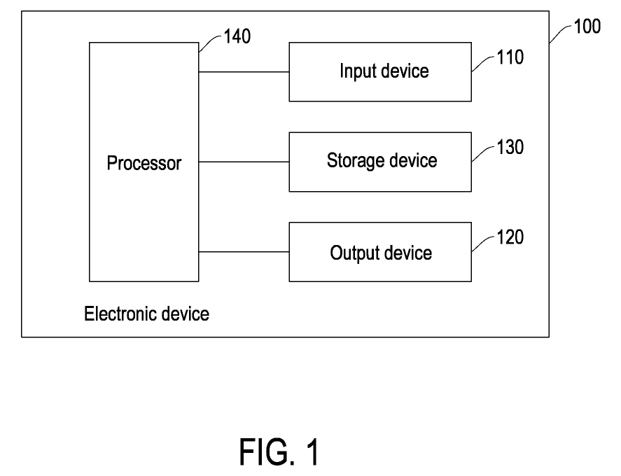

Referring to FIG. 1, in an embodiment, the electronic device 100 may include an input device 110, an output device 120, a storage device 130, and a processor 140. The electronic device 100 may be, for example, a smart phone, a laptop computer, a tablet computer, a desktop computer, or a smart wearable device, etc., that has virtual assistant services, but the disclose is not limited thereto.

The input device 110 is configured to receive user input information, such as a touch input device, keyboard, mouse, or microphone, etc., but the disclose is not limited thereto. In this embodiment, the input device 110 may be configured to receive user commands input by the user.

The storage device 130 is configured to store data and software modules (such as operating systems, applications, drivers) for the processor 140 to access. In one embodiment, the storage device 130 includes any type of fixed or removable random access memory (RAM), read-only memory (ROM), flash memory, hard disk, or a combination thereof, but the disclose is not limited thereto.

The output device 120 is configured to output information, such as a speaker or display, etc. The disclosure does not impose any limitations in this regard. In one embodiment, the display includes a Liquid Crystal Display (LCD), Light-Emitting Diode (LED) display, Organic Light-Emitting Diode (OLED) display, or other types of displays, but the disclose is not limited thereto. The disclosure does not impose any limitations in this regard. In this embodiment, the display may show the user interface for the virtual assistant service.

The processor 140 is coupled to the input device 110, the output device 120, and the storage device 130. In one embodiment, the processor 140 includes a central processing unit (CPU), an application processor (AP), or other programmable general-purpose or special-purpose microprocessors, digital signal processors (DSP), image signal processors (ISP), graphics processing units (GPU) or other similar devices, integrated circuits or combinations thereof, but the disclose is not limited thereto. The processor 140 may access and execute software modules recorded in the storage device 130 to implement the virtual assistant operation method in this embodiment of the invention. The aforementioned software modules may be broadly interpreted to mean instructions, instruction sets, code, program code, programs, applications, software packages, threads, processes, functions, etc., regardless of whether they are referred to as software, firmware, middleware, microcode, hardware description language, or otherwise, but the disclose is not limited thereto.

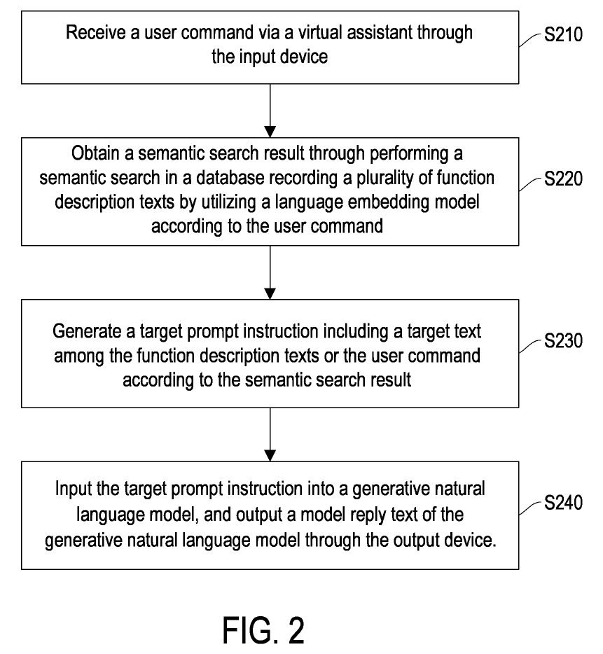

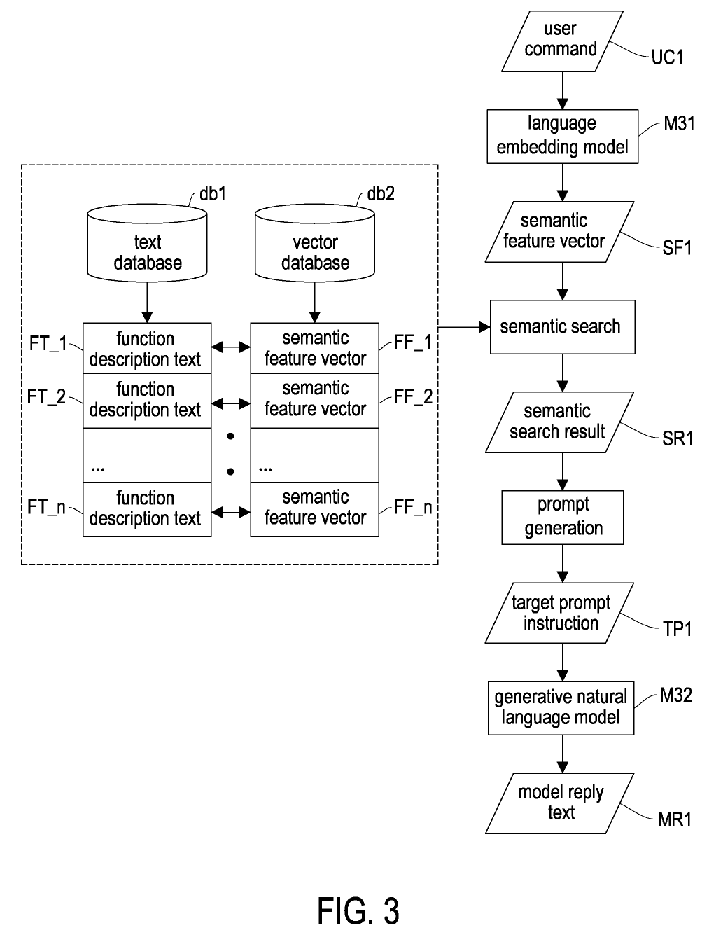

Referring to both FIG. 1 and FIG. 2, the method of this embodiment is applicable to the electronic device 100 described above. The following will explain the detailed steps of the virtual assistant operation method in this embodiment in conjunction with the various components of the electronic device 100. To clearly explain the possible embodiment of the disclosure, the following explanation will be supplemented with FIG. 3. Please also refer to FIG. 3.

In step S210, the processor 140 may receive a user command UC1 via a virtual assistant through the input device 110. In some embodiments, the virtual assistant may be an embedded digital assistant integrated into the operating system (OS). The virtual assistant running by the processor 140 may accept the user command UC1 through the input device 110. Furthermore, the virtual assistant may provide audio output or visual output corresponding to the user command UC1 through the output device 120 of the electronic device 100.

In various embodiments, the user command UC1 may be a voice input instruction or a text input instruction. For example, the user may utilize the input device 110 to enter the user command UC1 in an input field of the user interface displayed on the display. Alternatively, the user may speak the user command UC1, and the processor 140 may receive the voice input via the input device 110. The user command UC1 is an unformatted natural language instruction.

In some embodiments, the user may wake up the virtual assistant by speaking a wake-up keyword, performing a specific wake-up gesture, or pressing a wake-up hotkey. During the wake-up period of the virtual assistant, the processor 140 may receive the user command UC1 via the virtual assistant.

In step S220, the processor 140 may perform a semantic search in a database recording multiple function description texts FT_1 to FT_n by utilizing a language embedding model M31 according to the user command UC1, thereby obtaining a semantic search result SR1.

The language embedding model M31 may be configured to convert input text into semantic feature vectors in a multi-dimensional feature space. In some embodiments, the language embedding model M31 may capture the semantics and contextual information of words. As shown in FIG. 3, the language embedding model M31 may be configured to convert the user command UC1 into a corresponding semantic feature vector SF1. In various embodiments, the language embedding model M31 may be, for example, a BERT (Bidirectional Encoder Representations from Transformers) model, a GPT (Generative Pre-trained Transformer) model, a Bag-of-Words Model, or a USE (Universal Sentence Encoder) model, etc., which is not limited in the disclosure.

In some embodiments, when the processor 140 performs the semantic search, the processor 140 searches for a target text with similar semantics from the text database db1 based on the semantic feature vector SF1 of the user command UC1. More specifically, the text database db1 records multiple function description texts FT_1 to FT_n. The function description texts FT_1 to FT_n may include multiple device knowledge texts associated with the electronic device 100 (such as operation suggestions, operation instructions, and basic device information, etc.). Alternatively, the function description texts FT_1 to FT_n may include multiple application assistance texts of third-party application functions that can be invoked by the virtual assistant (such as third-party application names and their available service contents, etc.).

As shown in FIG. 3, the function description texts FT_1 to FT_n in the text database db1 may be converted into corresponding multiple semantic feature vectors FF_1 to FF_n by utilizing the language embedding model M31. The semantic feature vectors FF_1 to FF_n of each function description text FT_1 to FT_n may be recorded in the vector database db2. Specifically, the semantic feature vectors FF_1 to FF_n may be stored in the vector database db2 by being correspondingly bound to the function description texts FT_1 to FT_n respectively. The text database db1 and the vector database db2 may be stored in the storage device 130.

When the processor 140 executes the semantic search, the processor 140 may calculate the semantic similarity between the semantic feature vector SF1 of the user command UC1 and each of the semantic feature vectors FF_1 to FF_n of the function description texts FT_1 to FT_n. For example, the processor 140 may calculate the cosine similarity, Euclidean Distance, or Manhattan Distance between two semantic feature vectors to obtain the semantic similarity between the semantic feature vector SF1 and each of the semantic feature vectors FF_1 to FF_n. In some embodiments, when the semantic similarity between two semantic feature vectors is higher than a threshold value, the processor 140 may determine that these two semantic feature vectors are similar to each other. When the semantic similarity between two semantic feature vectors is not higher than the threshold value, the processor 140 may determine that these two semantic feature vectors are not similar to each other.

Based on the binding relationship between multiple semantic feature vectors FF_1 to FF_n and function description texts FT_1 to FT_n, the processor 140 may determine whether the function description texts FT_1 to FT_n include target texts semantically similar to the user command UC1 according to the semantic similarity between each semantic feature vector FF_1 to FF_n and the semantic feature vector SF1. For example, when the semantic similarity between the semantic feature vector FF_1 and the semantic feature vector SF1 meets the search criteria, the processor 140 may determine that the semantic search result SR1 includes a target text matching the user command UC1, and this target text is the function description text FT_1. When the semantic similarity between all semantic feature vectors FF_1 to FF_n and the semantic feature vector SF1 does not meet the search criteria, the processor 140 may determine that the semantic search result SR1 does not include a target text matching the user command UC1.

In step S230, the processor 140 may generate a target prompt instruction TP1 including a target text among the multiple function description texts FT_1 to FT_n or the user command UC1, based on the semantic search result SR1.

In some embodiments, when the semantic search result SR1 includes a target text matching the user command UC1, the processor 140 may generate a target prompt instruction TP1 including the target text among the multiple function description texts FT_1 to FT_n.

Furthermore, when the semantic search result SR1 includes a target text matching the user command UC1, the target prompt instruction TP1 including the target text may be configured to request the generative natural language model M32 to generate a model output according to the target text. On the other hand, when the semantic search result SR1 does not include a target text matching the user command UC1, the processor 140 may generate a target prompt instruction TP1 including the user command UC1. Furthermore, when the semantic search result SR1 does not include a target text matching the user command UC1, the processor 140 may infer that the user command UC1 belongs to general chat-oriented content, and the target prompt instruction TP1 including the user command UC1 may be configured to request the generative natural language model M32 to directly generate a model output according to the user command UC1.

In step S240, the processor 140 may input the target prompt instruction TP1 into a generative natural language model M32, and outputs the model reply text MR1 of the generative natural language model M32 via the output device 120. The generative natural language model M32 may output natural language text based on the input text. In various embodiments, the generative natural language model M32 may be, for example, a GPT (Generative Pre-trained Transformer) model, a T5 model, or a LLaMA (Large Language Model Meta AI) model, etc., which is not limited in this disclosure. In other words, the generative natural language model M32 may respond to receiving the target prompt instruction TP1 by outputting the model reply text MR1. Afterwards, the virtual assistant may provide the model reply text MR1 to the user via the output device 120.

In some embodiments, the model parameters of the generative natural language model M32 may be recorded in the storage device 130, and the generative natural language model M32 may run on the local electronic device 100. Furthermore, in the embodiments, the virtual assistant of the electronic device 100 may more accurately understand the user's complex requirements through the local database and semantic search. In summary, the electronic device 100 does not need to rely on cloud services to understand the user command UC1 and generate the virtual assistant's reply content, thereby enhancing privacy protection, data security, and avoiding response delays.

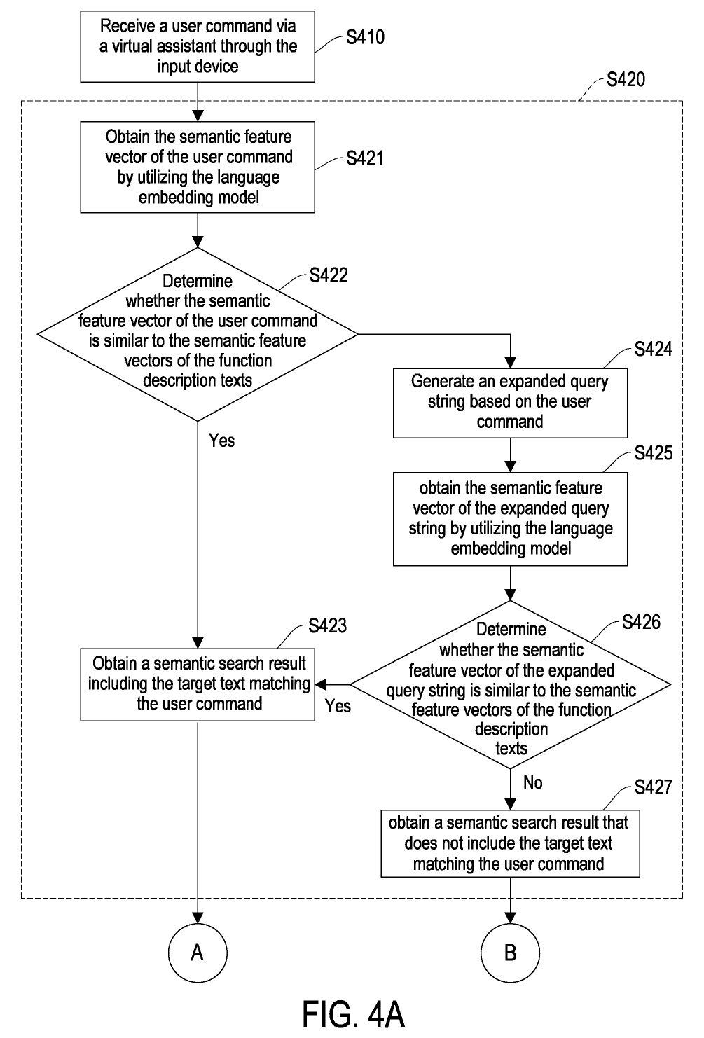

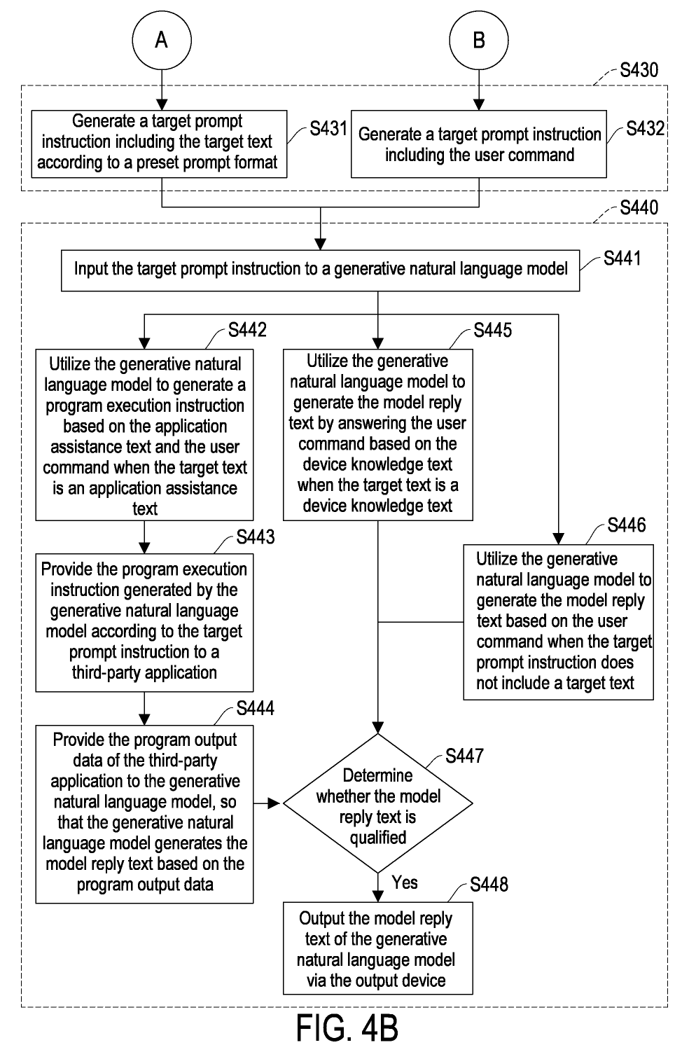

Referring to FIG. 1 and FIG. 4A to FIG. 4B simultaneously, the method of this embodiment is applicable to the electronic device 100 described above. The following will explain the detailed steps of the virtual assistant operation method of this embodiment in conjunction with the various components of the electronic device 100.

In step S410, the processor 140 may receive a user command via a virtual assistant through the input device 110.

In step S420, the processor 140 may perform a semantic search in a database recording multiple function description texts based on the user command by utilizing a language embedding model, thereby obtaining a semantic search result. In some embodiments, the processor 140 may conduct semantic searches on multiple text databases, where these text databases record texts of different text classifications respectively. In some embodiments, step S420 may be implemented as steps S421 to S427.

In step S421, the processor 140 may utilize the language embedding model to obtain the semantic feature vector of the user command. In step S422, the processor 140 may determine whether the semantic feature vector of the user command is similar to the multiple semantic feature vectors of the multiple function description texts. The operating principles of steps S421 to S422 have been described above and will not be repeated here.

In step S423, when the semantic feature vector of the user command is similar to the semantic feature vector of the target text among the multiple function description texts, the processor 140 may obtain a semantic search result including the target text matching the user command. The target text is one of the function description texts. When the semantic feature vector of the user command is similar to the semantic feature vector of the target text among the multiple function description texts, it means that the processor 140 can search out the target text matching the semantic feature vector of the user command from multiple function description texts in the database. Based on this, in step S423, the processor 140 may obtain a semantic search result including the target text matching the user command.

On the other hand, in step S424, when the semantic feature vector of the user command is not similar to the multiple semantic feature vectors of the multiple function description texts, the processor 140 may generate an expanded query string based on the user command. In other words, when the processor 140 cannot retrieve any function description text from the database that matches the semantic feature vector of the user command, the processor 140 may generate an expanded query string based on the user command. That is, the processor 140 may expand the user command into various diversified strings to search for text content from the database that may meet the user's requirements.

In some embodiments, the processor 140 may generate an expanded query string by utilizing a generative natural language model based on a query expansion prompt and the user command. Specifically, the query expansion prompt is configured to request the generative natural language model to generate strings with similar semantics or word meanings. Therefore, when the generative natural language model receives the query expansion prompt and the user command, the generative natural language model may output an expanded query string with similar semantics or word meanings to the user command. Alternatively, in some embodiments, the expanded query string may be generated based on the principle of word association. Furthermore, the disclosure does not limit the number of expanded query strings; it can be set according to practical applications.

In step S425, the processor 140 may utilize the language embedding model to obtain the semantic feature vector of the expanded query string. In step S426, the processor 140 may determine whether the semantic feature vector of the expanded query string is similar to the multiple semantic feature vectors of the multiple function description texts. The operations of obtaining semantic feature vectors and determining semantic similarity in steps S425 to S426 have been explained above and will not be repeated here.

In step S423, when the semantic feature vector of the expanded query string is similar to the semantic feature vector of the target text among the multiple function description texts, the processor 140 may obtain a semantic search result including the target text matching the user command. Furthermore, when the semantic feature vector of the expanded query string is similar to the semantic feature vector of the target text among the multiple function description texts, the processor 140 may determine a semantic search result including the target text.

In step S427, when the semantic feature vector of the expanded query string is not similar to the multiple semantic feature vectors of the multiple function description texts, the processor 140 may obtain a semantic search result that does not include the target text matching the user command.

Additionally, it should be noted that in some embodiments, the processor 140 may repeatedly execute steps S424 to S426 to compare whether the semantic feature vectors of multiple expanded query strings are similar to the multiple semantic feature vectors of the multiple function description texts. When the number of expanded query strings reaches a certain quantity and the semantic feature vectors of these expanded query strings are all not similar to the multiple semantic feature vectors of the multiple function description texts, the processor 140 may determine a semantic search result that does not include the target text matching the user command.

Next, referring to FIG. 4B. In step S430, the processor 140 may generate a target prompt instruction including a target text among the multiple function description texts or the user command based on the semantic search result. In some embodiments, step S430 may be implemented as steps S431 to S432.

In step S431, when the semantic search result includes the target text matching the user command, the processor 140 may generate a target prompt instruction including the target text according to a preset prompt format. In other words, when the processor 140 finds a target text with similar semantics from the text database based on the user command or its expanded query string, the processor 140 may generate a target prompt instruction including the target text according to a preset prompt format.

In some embodiments, when the target text is a device knowledge text, the processor 140 may generate a target prompt instruction including the target text according to a first preset format. For example, assuming the target text is an operational suggestion recorded in the text database explaining how to solve device power consumption, the target prompt instruction that the processor 140 may generate can be "Please reply to 'user command' based on 'target text'". In other words, the target text may include a device knowledge text, and the target prompt instruction may be configured to request the generative natural language model to answer the user command based on the device knowledge text.

For example, suppose the user command is "What should I do if my mobile phone consumes too much power?". The processor 140 may search for one or more target texts from the device knowledge database based on the semantic feature vector of "What should I do if my mobile phone consumes too much power?", and these target texts are respectively "Power-saving techniques 1 for mobile phone power consumption", "Power-saving techniques 2 for mobile phone power consumption", and "Power-saving techniques 3 for mobile phone power consumption". Therefore, the target prompt instruction generated by the processor 140 may include "Please answer 'What should I do if my mobile phone consumes too much power?' based on the following documents" and "'Power-saving techniques 1 for mobile phone power consumption', 'Power-saving techniques 2 for mobile phone power consumption', and 'Power-saving techniques 3 for mobile phone power consumption'". Based on this, the generative natural language model will reply to the user's question according to the "Power-saving techniques 1 for mobile phone power consumption", "Power-saving techniques 2 for mobile phone power consumption", and "Power-saving techniques 3 for mobile phone power consumption" recorded in the text database, thereby improving the accuracy and correctness of the reply.

In some embodiments, when the target text is an application assistance text, the processor 140 may generate a target prompt instruction including the target text according to a second preset format. For example, assuming the target text is the application name of a third-party application and corresponding application function, the target prompt instruction generated by the processor 140 can be "Please generate a program execution instruction to control 'the application name of the third-party application' to execute 'application function' according to 'user command'". The aforementioned program execution instruction may be an API instruction provided to the third-party application. In other words, the target text may include an application assistance text, and the target prompt instruction is configured to request the generative natural language model to generate a program execution instruction based on the application assistance text and the user command.

In step S432, when the semantic search result does not include a target text matching the user command, the processor 140 may generate a target prompt instruction including the user command. In other words, when the processor 140 is unable to find a target text with similar semantics from the text database based on the user command or its expanded query string, the processor 140 may directly use the user command as the target prompt instruction.

In step S440, the processor 140 may input the target prompt instruction to a generative natural language model, and outputs the model reply text of the generative natural language model via the output device 120. In some embodiments, step S440 may be implemented as steps S441 to S448.

In step S441, when the target text is an application assistance text, the processor 140 may input the target prompt instruction to a generative natural language model. In step S442, when the target text is an application assistance text, the processor 140 may utilize the generative natural language model to generate a program execution instruction based on the application assistance text and the user command. Then, in step S443, the processor 140 may provide the program execution instruction generated by the generative natural language model according to the target prompt instruction to a third-party application. In step S444, the processor 140 may provide the program output data of the third-party application to the generative natural language model, so that the generative natural language model generates the model reply text based on the program output data.

For example, suppose the user command is "Control living room air conditioner to turn on at 6 PM". The processor 140 may search for one or more target texts from the device knowledge database based on the semantic feature vector of "Control home air conditioner to turn on at 6 PM", and these target texts may be "Smart home appliance control application sets device turn-on time". Thus, the processor 140 may generate an API instruction (i.e., program execution instruction) to be provided to the smart home appliance control application (i.e., third-party application) based on the target text "Smart home appliance control application sets appliance turn-on time" and the user command "Control home air conditioner to turn on at 6 PM". The program execution instruction may include the time parameter "6 PM", the control target parameter "living room air conditioner", and the program action "turn on device" from the user command. Consequently, the smart home appliance control application may execute subsequent application functions after obtaining the program execution instruction, and reply with an application function execution result (i.e., program output data). Then, the generative natural language model may output the model reply text based on the application function execution result. For instance, when the application function execution result is "setting completed", the model reply text of the generative natural language model may be "The living room air conditioner will turn on at 6 PM". When the application function execution result is "setting failed", the model reply text of the generative natural language model may be "Failed to set the living room air conditioner".

Moreover, in step S445, when the target text is a device knowledge text, the processor 140 may utilize the generative natural language model to generate the model reply text by answering the user command based on the device knowledge text. In other words, when the processor 140 searches for semantically similar device knowledge text in the device knowledge database according to the user command, the processor 140 may utilize the generative natural language model to generate the model reply text by answering the user command based on the device knowledge text.

Alternatively, in step S446, when the target prompt instruction does not include a target text, the processor 140 may utilize the generative natural language model to generate the model reply text based on the user command. That is to say, in some embodiments, when the processor 140 does not search for any semantically similar text from the local database according to the user command, the processor 140 may directly input the user command into the generative natural language model.

In step S447, the processor 140 may determine whether the model reply text is qualified. In some embodiments, the processor 140 may utilize a natural language classifier or further use a generative natural language model to determine whether the model reply text is qualified. The input of the natural language classifier is text, and its output is the probability of being qualified. If the output of the natural language classifier is below a threshold, the processor 140 determines that the input model reply text is not qualified. When the processor 140 uses the generative natural language model to make the determination, the natural language model may output which unqualified categories the input model reply text may belong to, such as violence, hate, harm, or sex-related content. Conversely, the processor 140 may determine that the model reply text is qualified. In step S448, when the model reply text is qualified, the processor 140 may output the model reply text of the generative natural language model via the output device 120. In this way, the user may obtain the model reply text generated by the virtual assistant utilizing the generative natural language model.

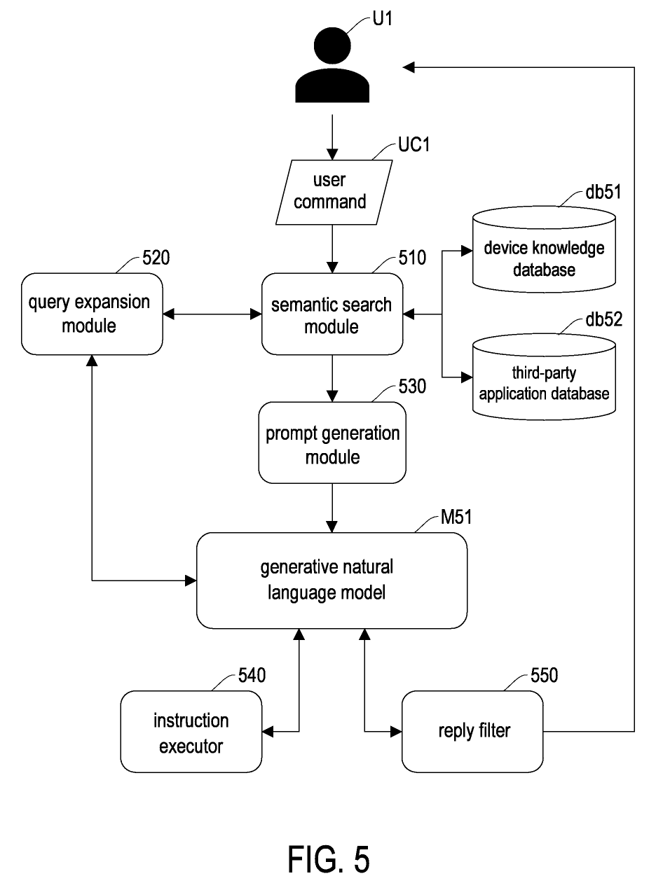

Referring to FIG. 5, which is a schematic diagram of a virtual assistant according to an embodiment of the disclosure. The user U1 may provide a user command UC1 to the virtual assistant. The semantic search module 510 of the virtual assistant may utilize a language embedding model to conduct semantic search on the device knowledge database db51 and the third-party application database db52 based on the user command UC1. The device knowledge database db51 may record multiple device knowledge texts, which may include device basic information, device operation suggestions, or device operation instructions, etc. The third-party application database db52 may record multiple application assistance texts, which may include multiple third-party applications and their executable application functions.

When the semantic search module 510 cannot search for device knowledge text or application assistance text matching the user command UC1 based on the semantic feature vector of the user command UC1, the query expansion module 520 of the virtual assistant may utilize the generative natural language model M51 to generate one or more expanded query strings based on the user command UC1. The semantic search module 510 may utilize the language embedding model to conduct semantic search on the device knowledge database db51 and the third-party application database db52 based on the one or more expanded query strings.

Next, the semantic search module 510 may provide the semantic search results to the prompt generation module 530 of the virtual assistant. The prompt generation module 530 may generate a target prompt instruction based on the semantic search results, and input the target prompt instruction to the generative natural language model M51. When the target prompt instruction includes a certain device knowledge text from the device knowledge database db51, the target prompt instruction may include that device knowledge text and the user command UC1, enabling the generative natural language model M51 to output a model reply text based on that device knowledge text and the user command UC1. When the semantic search results do not include any device knowledge text or application assistance text matching the user command UC1, the target prompt instruction will be the user command UC1, and the generative natural language model M51 may output a model reply text based on the user command UC1.

When the target prompt instruction includes a certain application assistance text from the device knowledge database db52, the target prompt instruction may include that application assistance text and the user command UC1, enabling the generative natural language model M51 to generate a program execution instruction based on that application assistance text and the user command UC1, and output the program execution instruction to the instruction executor 540.

The instruction executor 540 may provide the program execution instruction to the third-party application, and input the program reply data from the third-party application to the generative natural language model M51. The generative natural language model M51 may output a model reply text based on the program reply data from the third-party application. Then, the reply filter 550 of the virtual assistant may determine whether the model reply text is qualified to decide whether to provide the model reply text to the user U1.

In summary, in this embodiment of the invention, semantic search may be conducted on a database recording multiple function description texts based on the user command, in order to generate a target prompt instruction to be input to the generative natural language model based on the semantic search results. Thus, the target prompt instruction may be input to the generative natural language model to generate a model reply text, enabling the virtual assistant to provide the model reply text to the user via the output device. Based on this, the virtual assistant may well understand diverse user commands and improve the correctness and accuracy of the virtual assistant's replies based on the recorded data in the database. In addition, through the local database, semantic search and generative natural language model, the virtual assistant does not need to rely on cloud services to understand user commands and generate reply content, thereby enhancing privacy protection, data security and avoiding response delays.

Although the disclosure has been revealed in the above embodiments, it is not intended to limit the disclosure. Any person skilled in the art may make minor modifications and refinements without departing from the spirit and scope of the disclosure. Therefore, the scope of protection of the disclosure should be defined by the appended claims and their equivalents.

What is claimed is:

1. A virtual assistant operation method, adapted to an electronic device comprising an input device and an output device, the method comprising:
receiving a user command via a virtual assistant through the input device;
obtaining a semantic search result through performing a semantic search in a database recording a plurality of function description texts by utilizing a language embedding model according to the user command;
generating a target prompt instruction comprising a target text among the plurality of function description texts or the user command according to the semantic search result; and
inputting the target prompt instruction to a generative natural language model, and outputting a model reply text of the generative natural language model through the output device.

2. The virtual assistant operation method as claimed in claim 1, wherein the step of obtaining the semantic search result through performing the semantic search in the database recording the plurality of function description texts by utilizing the language embedding model according to the user command comprises:
obtaining a semantic feature vector of the user command by utilizing the language embedding model;
determining whether the semantic feature vector of the user command is similar to a plurality of semantic feature vectors of the plurality of function description texts; and
obtaining the semantic search result comprising the target text matching the user command when the semantic feature vector of the user command is similar to the semantic feature vector of the target text among the plurality of function description texts.

3. The virtual assistant operation method as claimed in claim 2, wherein the step of obtaining the semantic search result through performing the semantic search in the database recording the plurality of function description texts by utilizing the language embedding model according to the user command comprises:
generating an expanded query string according to the user command when the semantic feature vector of the user command is not similar to the plurality of semantic feature vectors of the plurality of function description texts;
obtaining a semantic feature vector of the expanded query string by utilizing the language embedding model;
determining whether the semantic feature vector of the expanded query string is similar to the plurality of semantic feature vectors of the plurality of function description texts; and
obtaining the semantic search result comprising the target text matching the user command when the semantic feature vector of the expanded query string is similar to the semantic feature vector of the target text among the plurality of function description texts.

4. The virtual assistant operation method as claimed in claim 3, wherein the step of generating the at least one expanded query string according to the user command comprises:
generating the expanded query string by utilizing the generative natural language model according to a query expansion prompt and the user command.

5. The virtual assistant operation method as claimed in claim 3, wherein the step of obtaining the semantic search result through performing the semantic search in the database recording the plurality of function description texts by utilizing the language embedding model according to the user command comprises:
obtaining the semantic search result not comprising the target text matching the user command when the semantic feature vector of the expanded query string is not similar to the plurality of semantic feature vectors of the plurality of function description texts.

6. The virtual assistant operation method as claimed in claim 1, wherein the step of generating the target prompt instruction comprising the target text among the plurality of function description texts or the user command according to the semantic search result comprises:
generating the target prompt instruction including the target text according to a preset prompt format when the semantic search result comprises the target text matching the user command; and
generating the target prompt instruction comprising the user command when the semantic search result does not comprise the target text matching the user command.

7. The virtual assistant operation method as claimed in claim 1, wherein the target text comprises a device knowledge text, and the target prompt instruction is configured to request the generative natural language model to answer the user command according to the device knowledge text.

8. The virtual assistant operation method as claimed in claim 1, wherein the target text comprises an application assistance text, and the target prompt instruction is configured to request the generative natural language model to generate a program execution instruction according to the application assistance text and the user command.

9. The virtual assistant operation method as claimed in claim 8, wherein the step of inputting the target prompt instruction to the generative natural language model and outputting the model reply text of the generative natural language model via the output device comprises:
providing the program execution instruction generated by the generative natural language model according to the target prompt instruction to a third-party application; and
providing program output data of the third-party application to the generative natural language model, to enable the generative natural language model to output the model reply text according to the program output data.

10. The virtual assistant operation method as claimed in claim 1, wherein the step of inputting the target prompt instruction to the generative natural language model and outputting the model reply text of the generative natural language model via the output device comprises:
determining whether the model reply text is qualified; and
outputting the model reply text of the generative natural language model via the output device when the model reply text is qualified.

11. An electronic device, comprising:
an output device;
an input device;
a storage device, recording a plurality of instructions; and
a processing device, connected to the output device, the input device and the storage device, configured to execute the instructions to:
receive a user command via a virtual assistant through the input device;
obtain a semantic search result through performing a semantic search in a database recording a plurality of function description texts by utilizing a language embedding model according to the user command;
generate a target prompt instruction comprising a target text among the plurality of function description texts or the user command according to the semantic search result; and
input the target prompt instruction to a generative natural language model, and output a model reply text of the generative natural language model through the output device.
